(19) United States
(12) Patent Application Publication
(10) Pub. No.: US 2005/0108940 A1
(43) Pub. Date: May 26, 2005

(54) Reactor wall for a fluidized-flow gasifier

(75) Inventors: Manfred Schingnitz, Freiberg (DE); Dietmar J. Friess, Kleinmachnow (DE); Dirk Volkmann, Oppin (DE); Bernd Holle, Freiberg (DE)

Correspondence Address: COHEN, PONTANI, LIEBERMAN & PAVANE, 551 FIFTH AVENUE, SUITE 1210, NEW YORK, NY, 10176, US

(73) Assignee: Future Energy GmbH

(21) Appl. No.: 10/723,210

(22) Filed: Nov. 24, 2003

(51) Int. Cl. B01J 7/00; C10B 1/00; C10J 3/68

(52) U.S. Cl. 48/101; 48/77; 48/111

(57) ABSTRACT

A reactor wall for a entrained-flow gasifier for the gasification of carbon-containing fuels, by-products, and waste materials at elevated temperature and pressure includes, arranged sequentially from an outside surface of the wall to an inside surface of the wall: a pressure shell (2); a water-carrying ring-shaped gap (3); a cooling wall (4); a thermally conductive ramming material (5); a solid layer of slag (6); a liquid film of slag (7); and a gasification chamber (1).

### BACKGROUND OF THE INVENTION

1. Field of the Invention

This invention relates generally to a wall for a reactor, and more specifically, to a composite wall formed from a number of materials and with a number of construction features, for use as a reactor wall for a fluidized-flow gasifier for gasifying solid and high viscosity liquid conventional fuels, by-products, and waste materials.

2. Description of the Related Art

As used herein, fuels, by-products, and waste materials are understood to be materials with an ash content of >0.3 wt. %, such as soft and hard coal, oils, tars, and sludges; by-products or waste materials originating from chemical processes and from the paper and cellulose industry, such as the black liquor from the kraft process; solid and liquid fractions from the waste and recycling industry, such as used oils, PCB-containing oils, plastics, and household trash fractions or the material obtained by the processing of those fractions; and products from petroleum processing such as heavy oils and petroleum coke.

In the technology of gas production, the autothermic fluidized-flow gasification of solid, liquid, and gaseous combustible materials has been known for many years. The ratio of fuel to oxygen-containing gasification agent is selected so that the higher carbon compounds are cracked to form synthesis gas components such as CO and H₂, which improve the quality of the synthesis gas, whereas the inorganic components are discharged as molten slag (Ch. Higman, “Gasification”, Elsevier 2003, p. 109).

Depending on which of the various systems that have been introduced to the technology is being used, the gasification gas and the molten slag consisting of the inorganic fraction can be discharged either separately or together from the reaction chamber of the gasification unit. See DE 197 18 131 A1.

To serve as the inner boundaries of the reaction space contour or chamber of the gasification reactor, and form a lining for the inner surface of the gasification chamber wall of the gasifier, both refractory-lined systems and cooled systems have previously been introduced into service (U.S. Pat. No. 4,343,626). Refractory-lined gasification systems offer the advantage of low heat losses, which means that, in terms of the energy balance, the supplied fuel is converted with relatively good efficiency. These systems are used only for ash-free fuels, however, because the liquid slag flowing down the inner surface of the reactor chamber during fluidized-flow gasification dissolves the refractory lining and therefore allows the unit to operate for only a limited time before the next expensive relining is required. To eliminate this disadvantage of ash-containing fuels, cooled systems of the “membrane wall” type were created, as described in U.S. Pat. No. 4,343,626. As a result of the cooling, a layer of solid slag initially forms on the surface facing the reaction chamber; the thickness of this layer increases until the slag leaving the gasification chamber starts to run in liquid form down this wall and leaves the reaction chamber together with, for example, the gasification gas. Systems of this type are highly resistant to wear and ensure long reactor runs.

A disadvantage, however, is that the structure of the reactor wall is very complicated, which can lead to considerable problems with respect to both production and operation. For example, the reactor wall consists of a pressureless water jacket; the pressure shell, which is protected against corrosion on the inside; and the cooling screen, which, like the conventional membrane wall used in boilers, consists of water-carrying cooling pipes welded together in a gas-tight manner, these pipes being provided with projecting anchor pins and then covered with a thin layer of SiC (U.S. Pat. No. 4,343,626). Between the cooling screen and the pressure shell, there is a cooling screen gap, which must be flushed with dry, oxygen-rich gas in order to prevent backflows and the formation of condensate. In view of the disadvantages of the state of the art, an object of the present invention is to create a reactor wall which is easy and reliable to operate, which is more easily and more cheaply constructed, and which is even simpler to operate because of the elimination of the cooling screen gap.

These objects, as well as other additional objects and advantages, are accomplished by the embodiments of the device according to the present invention.

### SUMMARY OF THE INVENTION

According to the present invention, a reactor wall for a fluidized-flow gasifier for carbon-containing fuels, by-products, and waste materials combined with an oxygen-containing oxidizing agent, and with the gasifier having a gasification chamber capable of withstanding pressures between ambient pressure and 100 bars [1,450 psi], in which the reaction chamber contour is surrounded by a cooling system, such that the pressure in the cooling system is always kept higher than the pressure in the reaction space, is provided alternatively with cooling channels that are welded onto the inside surface of the pressure shell and with a profiled cooling wall, which forms a ring-shaped gap within at least a portion of the gasification chamber formed by the pressure shell. A cooling medium is circulated through both the cooling channels and the ring-shaped gap. The components are designed so that that the pressure differences between the cooling channels or the ring-shaped gap and the gasification chamber are absorbed by the cooling channels welded to the pressure shell or by the profiled cooling wall. The pressure in the cooling channels and in the ring-shaped gap is maintained at 1-2 bars [14.5-29.0 psi] above the pressure in the gasification chamber. This pressure difference is intended to make it impossible, in the event of a leak, for gasification gas to escape from the gasification chamber into the cooling channels or into the ring-shaped gap; instead, cooling medium will always, in such a case, enter the gasification space. The cooling medium utilized and circulated through the cooling channels or ring-shaped gap is a liquid coolant, typically water.

Composite reactor wall devices of the present invention are constructed as follows, proceeding sequentially from the outside to the inside: a pressure shell; alternatively, cooling channels or a cooling gap; a protective refractory layer of, for example, SiC ramming mass; a coating of solidified slag; and a film of liquid slag.

It is advantageous to the invention for the pressure and the temperature in the cooling channels and in the ring-shaped gap to be controlled automatically in such a way that the state can be above or below the boiling point of the cooling medium.

It is essential that the protective refractory layer is attached to the cooling channels or the perforated cooling wall. One way to accomplish this is by use of pin-like or flared-out anchors, which are welded onto the channels or the wall.

The composite reactor wall according to the invention is suitable for the gasification of fuels, by-products, and waste materials of varying ash content and for the simultaneous gasification of carbon-containing gases, liquids, and carbon-containing solids. According to one aspect of the present invention, it is provided that the inner contour of the reaction chamber for the gasification process (inner layer of the gasification chamber reactor wall), is bounded by a layer of solidified slag. As a result of the intensive cooling, the liquid slag which forms during the gasification process at temperatures of 900-1,600° C. [1,652-2,912° F.] solidifies and forms a solid layer of slag, which thus acts as a layer of thermal insulation.

According to one embodiment of the design, the cooling wall is formed as a series of water-carrying half-tubes, which are welded to the pressure shell. It is advantageous to fasten anchors to the half-tubes to provide for the separate attachment of the ramming mass. The half-tubes do not necessarily have to be semicircular. It can be advantageous for the tubes to have some other shape, such as an elliptical shape.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

The present invention is more completely explained and understood in the following in view of three accompanying drawing figures which illustrate certain aspects of the invention, wherein:

FIG. 1 shows a cross section through the contour of the reaction chamber with the pressure shell, the ring-shaped gap, the cooling wall, the layer of slag, and the film of slag;

FIG. 2 shows a view of the cooling wall, to which anchors are attached; and

FIG. 3 shows a view of the water-carrying half-tubes, which form the cooling wall.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### DETAILED DESCRIPTION OF THE PRESENTLY PREFERRED EMBODIMENTS

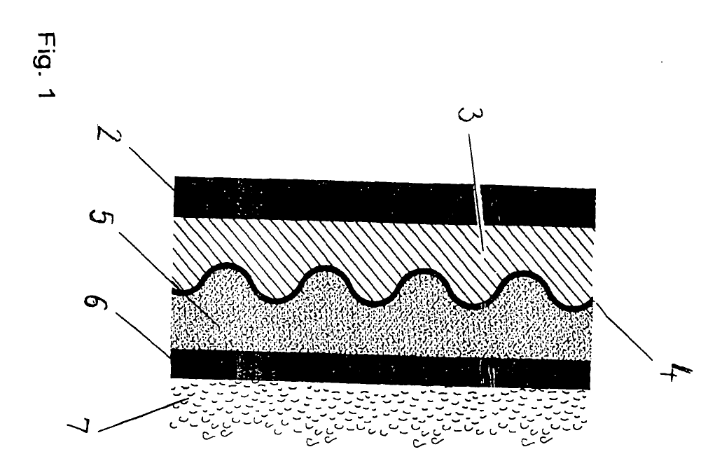

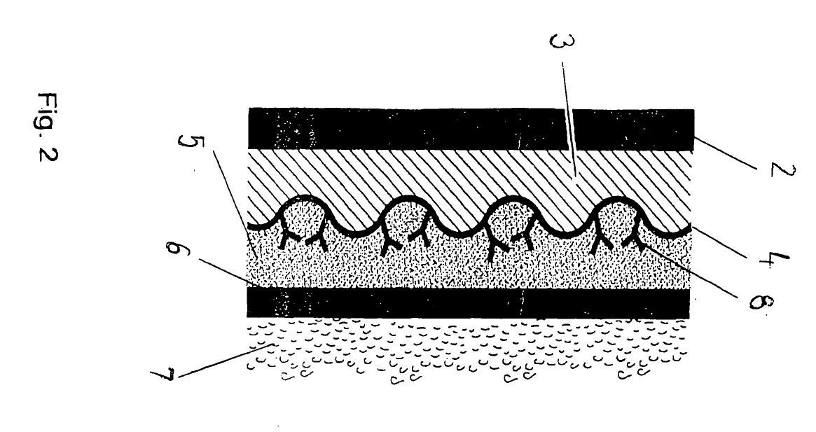

Referring now to FIG. 1, which shows the contour of the fabrication of a reaction chamber wall, for a reactor for the gasification of fuels, by-products, and waste materials with oxygen or an oxygen-containing oxidizing agent, at temperatures of 900-1,700° C. [1,652-3,092° F.] and at pressures of up to 100 bars [1,450 psi], wherein the high temperature, high pressure material within a gasification chamber 1 of the reactor is in contact with an inner surface of inner pressure shell 2 of the reaction chamber wall. Adjacent an opposite, outer surface of the inner pressure shell 2 there is a ring-shaped gap 3, surrounding at least part of the gasification chamber 1, through which water flows, and which is bounded at an opposite end by a cooling wall 4. According to one embodiment, the cooling wall 4 is fabricated in a corrugated manner. The temperature in the water-carrying ring-shaped gap 3 is below 600° C. [1,112° F.], and preferably is below 300° C. [572° F.]. The cooling wall 4 is coated with a refractory ramming mass 5 of silicon carbide with good thermal conductivity. As a result of the low temperatures in the ring-shaped gap 3, the temperature at the inside surface of the ramming mass 5 is far below the melting point of the ash being introduced with the fuel, by-product, or waste material; after the ash has been melted in the gasification chamber 1, which is at a temperature of 900-1,700° C. [1,652-3,092° F.], it therefore solidifies when it arrives at the surface of the ramming mass and forms there a layer of solid slag 6. The solid slag layer 6 continues to increase in thickness until the temperature on the side facing the gasification chamber 1 is above the melting point of the ash. The liquid slag formed from the ash arriving at the wall from this point on now runs down the solid slag layer as a film 7 of liquid slag and leaves the gasification space 1 together with the gasification gas. Fixation means 8 can be attached to the cooling wall 4 to provide a separate means for holding the ramming mass 5 in place, as shown in FIG. 2.

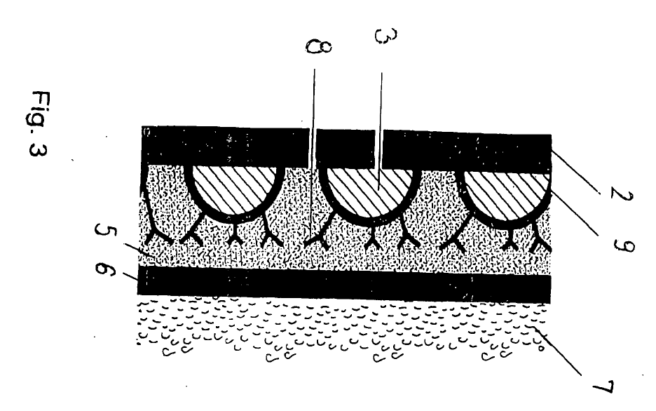

FIG. 3 shows an exemplary embodiment of the reaction chamber contour for a gasifier for fuels, by-products, and waste materials with oxygen or an oxygen-containing oxidizing agent at temperatures of 900-1,700° C. [1,652-3,092° F.] and at pressures of up to 100 bars [1,450 psi], in which, inside the pressure shell 2, the cooling wall 9 consists of water-carrying half-tubes 3, having a semi-circular cross sectional area, which are attached, such as by welding, onto the pressure shell 2. In alternative embodiments, the cooling wall 9 can have an alternative shape and does not have to be made up of semicircular half-tubes. For example, the half tubes may also be elliptical in shape. The half-tubes shown by way of example in FIG. 3 can also have fixation means 8, in the form of anchors or pins, as a separate means of holding the ramming mass 5 in place. As discussed in connection with the ring-shaped gap 3 in Example 1, the temperatures in the cooling wall 9 constructed of half-tubes is again less than 600° C. [1,112° F.], and preferably less than 300° C. [572° F.], so that the same types of effects are obtained.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A composite reactor wall for a an entrained-flow gasifier, said reactor wall comprising the following elements (a-f), arranged sequentially from an outside of said reactor wall to an inside of said reactor wall:
a) a pressure shell (2), having an outer surface and an inner surface, and forming an enclosed gasification chamber;
b) a ring-shaped gap (3), adjacent to at least a portion of said inner surface of said pressure shell, through which gap a cooling medium is circulated;
c) a cooling wall (4), forming an inner wall of said ring shaped gap (3);
d) a thermally conductive ramming mass (5), adjacent to said cooling wall (4);
e) a solid layer of slag (6), adjacent to said thermally conductive ramming mass (5); and
f) a liquid film of slag (7), adjacent to said solid layer of slag (7), and in contact with reaction material in said gasification chamber of said gasifier.

2. The reactor wall according to claim 1, further comprising fixation means (8) attached to said cooling wall (4) to provide separate means for holding said ramming mass (5) in place.

3. The reactor wall according to claim 2, wherein said fixation means (8) is selected from the group consisting of pins and anchors.

4. The reactor wall according to claim 1, further comprising cooling medium-carrying half-tubes (9), which are attached to said pressure shell (2) to form said cooling wall (4).

5. The reactor wall according to claim 4, further comprising fixation means (8) for attaching said thermally conductive ramming mass (5) to said cooling medium-carrying half-tubes (9).

6. The reactor wall according to claim 5, wherein said fixation means (8) is selected from the group consisting of pins and anchors.

7. The reactor wall according to claim 4, wherein said cooling medium-carrying half tubes (9) have a cross-sectional shape selected from the group consisting of semi-circular and elliptical.

8. The reactor wall according to claim 4, wherein said cooling medium is water.

9. The reactor wall according to claim 1, wherein said ramming mass is silicon carbide.
